(19) United States
(12) Patent Application Publication
(10) Pub. No.: US 2016/0242585 A1
(43) Pub. Date: Aug. 25, 2016

(54) Handheld Hanger Spacing Device

(71) Applicant: Brian Wayne Jones, Cleveland, GA (US)

(72) Inventor: Brian Wayne Jones, Cleveland, GA (US)

(21) Appl. No.: 15/046,220

(22) Filed: Feb. 17, 2016

Related U.S. Application Data
(60) Provisional application No. 62/118,496, filed on Feb. 20, 2015.

(51) Int. Cl. A47G 25/00; B25J 1/04

(52) U.S. Cl. CPC A47G 25/00; B25J 1/04

(57) ABSTRACT

A handheld hanger spacing device for separating garment hangers suspended from a supporting rod.

### CROSS-REFERENCE TO RELATED APPLICATIONS

This application claims the benefit of U.S. Provisional Application filed Feb. 20, 2015, disclosure of which is incorporated herein by reference.

### BACKGROUND OF THE INVENTION

This is a hanger spacing device for separating items hung on garment hangers that are suspended from a supporting rod. The tool evolves from the need to efficiently organize and separate hung items for aesthetic (and other) purposes. In the retail environment, or otherwise the need for aesthetic separation exists and their current method for the alignment which consists of their employees or others using their fingers to exact a separation between hangers and those adjacent to them.

In past attempts, hanger spacing devices invariably either attach to the supporting rod or to the hangers themselves. U.S. Pat. No. 5,018,694 said spacers are hooks that attach to the supporting rod and, while separating the hangers present a possibly offensive look (when used in a retail setting). U.S. Pat. No. 393,371 S a block is attached to the hanger itself also creating a possibly unwanted visual. U.S. Pat. No. 5,076,447 a rather ornate contraption is used, with a set of pulleys that obtains separation but remains intact after use, as do the others mentioned.

This device is a handheld hanger spacer that provides equidistant spacing yet is removed after the task is completed (which is an improvement over already existing devices).

### SUMMARY OF THE INVENTION

Utility of the present invention, my apparatus or device for separating and spacing of garment hangers or the like is achieved by inserting ones' hand in the middle slot or opening and projecting the thumb (of that hand) laterally along the back edge of the tool so that now a hanger is located in each “V” of the tool. Pushing the tool forward will seat each hanger inside the base of the “V” as to allow for equal separation of the hangers.

Alternately, the apparatus serves the function of transporting an equally spaced series of hung items from one location to another. This utility could involve but not be limited to, the initial loading of hung items onto a supporting rod or for moving sets of hung items from one location to another.

### BRIEF DESCRIPTIONS OF DRAWINGS

FIG. 1 Not-to Scale Isometric rendering of the handheld hanger spacing Device.

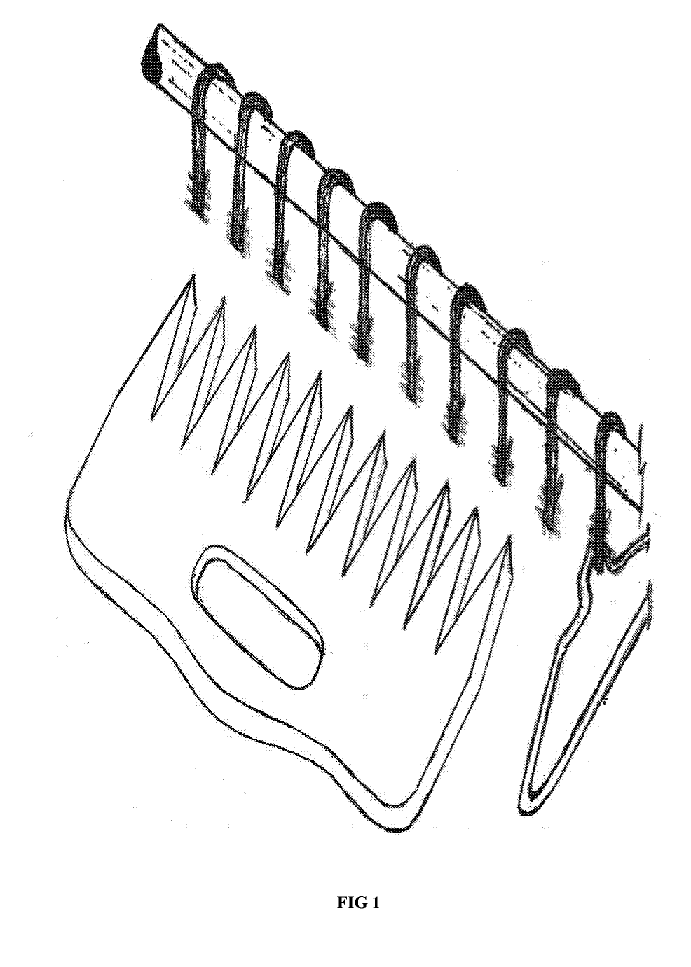

FIG. 2 Not-to-scale single plane rendering of the handheld spacing device

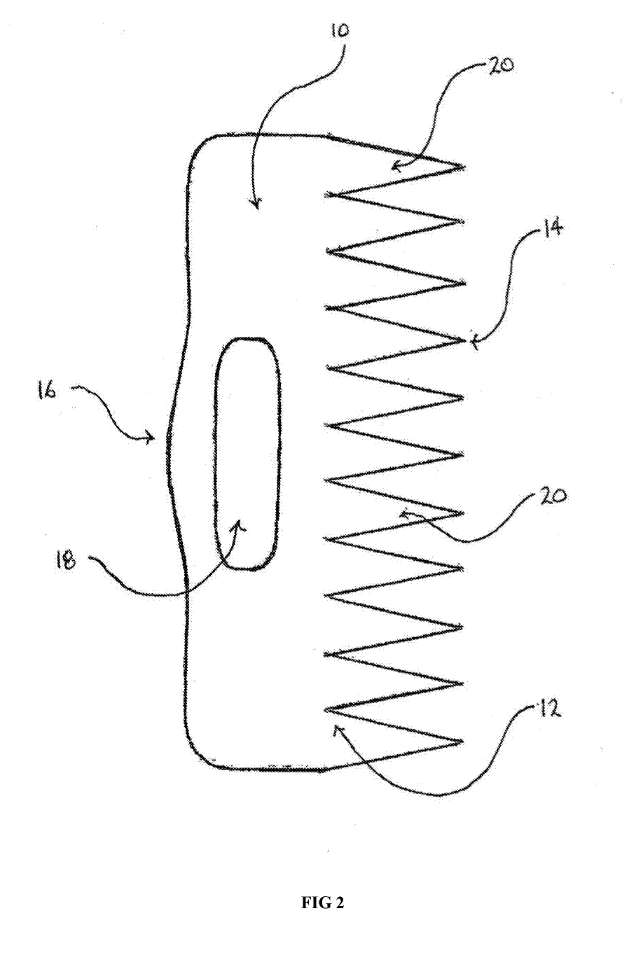

### REFERENCE NUMERALS IN FIG. 2

10 Body of the device

12 Base of the “V” shaped spacing slot 14 Apex of the alignment teeth

16 Convex handle of the device

18 Opening for the hand used for grasping the device

### DETAILED DESCRIPTION OF INVENTION

This invention is a Hanger Spacing Device for rapid and repetitive spacing of items hung on garment hangers suspended from a supporting rod.

In FIG. 2, reference numeral 10 indicates the body of the device which is preferably made of ¾″ red oak stained and protected with 3 coats of clear enamel. The body measures 11″ in length and 6⅝ in width

Numeral 14 in FIG. 2 is the tip of the device that is to be inserted between the garment hangers. For general consideration, numerals 14 and 12 represent the Apex and the Base, respectively, of numeral 20 or what will herein be referred to as the teeth of the device. The preferred distance between these teeth (numeral 20) is 1″. These teeth are slightly rounded at their Apex to add strength and reduce the possibility of breakage, snagging and the like.

Numeral 18 in FIG. 2 is the opening into which the user will insert his/her hand to make use of the device. This slot measures 1½″ wide by 4″ in length and penetrates completely through the body of the device. This slot also has rounded, or chamfered, edges to promote comfort ability and ease of use.

Numeral 16 in FIG. 2 refers to the handle of the device. The handle section protrudes from the main body, numeral 10 by ½″ in a gently sloping convex curve. The gentle curve of the handle as shown in numeral 16 of FIG. 2 supports the device in the hand and encourages the extension of the users thumb laterally on the handle to provide even greater support for the utilization of the device.

### EMBODIMENTS

As required, the preferred embodiment of the apparatus is disclosed herein, however, it is to be understood that the apparatus may be embodied in several and varied forms. Therein, the detailed description and FIGs disclosed in this document are not to be interpreted as limiting, but merely as a basis to substantiate the claim(s) herein.

Other embodiments could include (but are not limited to) the apparatus being comprised of other wood species, steel, aluminum, ABS, Plastic, or the like.

Furthermore, the spacing of the teeth and between the teeth referred to in the detailed description could be changed to facilitate any required spacing of objects, hung or otherwise, as alternate embodiments derived from the preferred embodiment. For instance, tooth spacing could be changed from 1″ to ¾″ to facilitate use with thinner items on a garment hanger or from 1″ to 1½″ for use with bulky hanged items such as winter coats and the like.

In addition, the overall dimensions of the device disclosed in the detailed description section of this document may be altered to reflect a variety of usage scenarios including, but not limited to, the number of hung items that require spacing and/or relocating.

### REFERENCED CITATIONS

U.S. Pat. No. 5,018,694 published Jul. 17, 1990 Inventor Heidi Olson Title Clothes Hanger Spacer, U.S. D393,371 S published Mar. 29, 1998 Inventor Steven Dunn Title Hanger Separator, U.S. Pat. No. 5,076,447 published Dec. 13, 1990 inventor Daniel DeBeer Title Holder to Position Clothes Hangers Relative to One Another.

1. A handheld device whose utility is achieved by inserting the teeth of the device in between hangers suspended by a supporting rod, thereby affecting equal spacing of the hangers along the supporting rod.
A handheld hanger spacing devise whose alternate utility is achieved by inserting the teeth of the device in-between hangers suspended by a supporting rod and, after insertion, using the device to relocate a group of hanged items.
